(19) United States
(12) Patent Application Publication
(10) Pub. No.: US 2001/0031326 A1
(43) Pub. Date: Oct. 18, 2001

(54) Packing material for mortar compositions

(76) Inventors: Joan Gross, Ausgsburg (DE); Herbert Ginter, Kaufbeuren (DE); Roland Sieber, Landsberg (DE)

Correspondence Address: BROWN & WOOD LLP, One World Trade Center, New York, NY, 10048-0557, US

(21) Appl. No.: 09/835,435

(22) Filed: Apr. 16, 2001

(30) Foreign Application Priority Data
Apr. 18, 2000 (JP) 100 19072.3

(51) Int. Cl. B32B 1/08

(52) U.S. Cl. 428/35.3

(57) ABSTRACT

A tubular bag, of a composite film (1) is formed to hold mortar compositions (2) and has an inner ply (8), enclosing the mortar composition. The inner ply (8) is formed by a polyethylene film (3) and a polyamide film (4). A metal foil (5), especially an aluminum foil, surrounds the inner layer (8) and is enclosed by a stretched plastics material film and forms an outer ply (9) of the composite film (1). Accordingly, the tubular bag of the composite film (1) has a long shelf life.

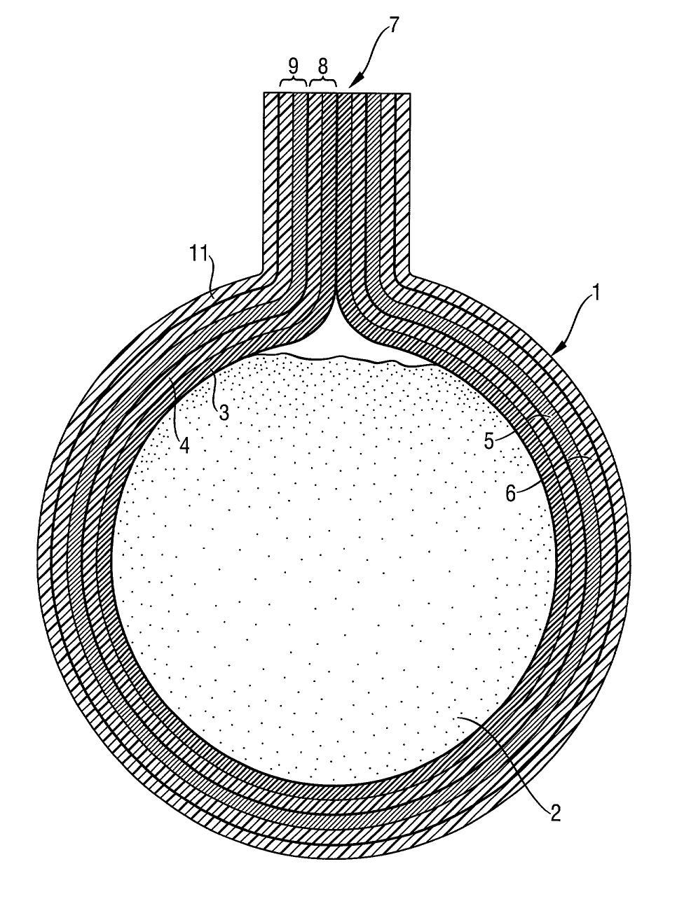

### BACKGROUND OF THE INVENTION

The invention relates to a tubular bag of a composite film for holding mortar compositions, with an inner ply, which encloses the mortar composition, and an outer ply surrounding the inner layer.

Bags of this known type are formed especially from a flat film, which has a longitudinal seam and, because it uses little in the way of material, is employed increasingly to pack flowable compositions, especially multi-component compositions, such as mortar compositions and the like. After being filled with a component of the composition, the tubular bags are closed off, for example, by welding, or by closing off their ends by means of a sealing clip, for example of metal. For processing the compositions, the filled tubular bags are supplied to expressing devices, which empty the bags by compressing them.

A tubular bag, of the type mentioned, is known from DE 4312192 A1 and consists of a composite film, which has a metal foil and an outer plastics material film.

A disadvantage of this known bag is that the composite film is affected within a short time by the chemicals stored in the tubular bag, such as benzyl alcohol or meta-xylylenediamine, so that it is no longer capable of functioning. Especially epoxide curing agents diffuse partially in appreciable amounts through the different plastics material films. Known, commercially used laminating adhesives are dissolved at least partly by these chemicals. As a result, laminated composites delaminate within a few weeks.

Furthermore, chemicals, emerging by diffusion, generally are dangerous to health. Moreover, if large amounts emerge, the product may no longer be usable.

### SUMMARY OF THE INVENTION

Therefore an object of the invention is to provide the tubular bag for holding mortar compositions, which is resistant to all chemicals present in mortar compositions and thus ensures a long shelf life for the filled tubular bags.

In accordance with the invention, the objective is accomplished owing to the fact that the inner ply has a polyethylene film or a polypropylene film as well as a polyamide film and the outer ply is not permeable to the curing agent for epoxides. Because the inner ply has a polyamide film, there is a barrier for certain aggressive chemicals, which are frequently used in mortar compositions, especially for amine-based epoxide curing agents, such as diethylenetriamine, propylenediamine, 1,3-diaminocyclohexane, isophoronediamine and m-xylylenediamine. The polyethylene film or the polypropylene film make self-sealing possible. The bag, formed by the inner ply, represents an independent and efficient tubular bag, which is entirely capable of functioning even if the delamination of the outer layer has progressed extensively. The outer ply represents a so-called total barrier and prevents diffusion of the chemicals contained in the tubular bag, especially of the amine based epoxide curing agents, through the composite film to the outside.

Preferably, the films of the inner ply are joined together by a bonding agent, such as ethyl vinyl alcohol, a chemical-resistant bond thus being formed. However, other classes of material can also be used as the bonding agent.

Advantageously, the two films of the inner ply are co-extruded in order to ensure that the inner ply of the tubular bag is produced economically. Instead of the co-extrusion method, it is also possible to use melt lamination.

Advisably, the inner layer of the outer ply is formed by a metal foil and its outer layer of a stretched plastics material film, in order to protect the remaining films of the outer ply, disposed towards the outside, and the environment from the diffusing chemicals. The metal foil, especially aluminum foil, contained in the outer ply, represents a so-called total barrier for the chemicals contained in the tubular bag. The metal foil preferably is enclosed by a stretched, plastics material film. By these means, the metal foil and the layers, which follow towards the inside, are protected from mechanical effects and ensure a higher dimensional stability. The stretched plastics material film can also be laminated on the metal foil.

Advantageously, the metal foil of the outer ply is enclosed by a stretched polypropylene film, especially one which can be sealed, in order to ensure the sealability of the outer ply.

Advantageously, the metal foil of the outer ply is enclosed by a stretched polyethylene terephthalate film or a stretched polyethylene naphthenate film, in order to ensure that it can be manufactured economically. Furthermore, the stretched polyethylene terephthalate film or the stretched polyethylene naphthenate film can have a further sealable film on the outside, such as a polyethylene film, in order to ensure the optimum sealability of the outer ply.

In a preferred manner, the metal foil of the outer ply is enclosed by a stretched polyamide film, in order to ensure optimum strength. Furthermore, the stretched polyamide film can have further sealable films on the outside, such as a polyethylene film, in order to ensure optimum sealability of the outer layer.

Appropriately, the inner ply and the outer ply are laminated together, so that a simple manufacturing process is ensured for the composite film. Instead of lamination, a bonding agent can be used to achieve an even higher resistance to the chemicals stored in the tubular bag.

In order to form a bag, edge regions of the composite film are bonded together at least partially preferably by a seam, in order to ensure that the formation of the bag is simple and economical. Advisably, the seam has two bonded inner layers, since by these means the cut edges of the film are not attacked directly by the chemicals stored in the tubular bag, especially by the amine-based epoxide curing agents. In this embodiment, the cut edge faces away from the interior of the tubular bag and accordingly is disposed outside of the region of activity of the chemicals contained in the tubular bag. In order to protect it against mechanical effects, the seam may be folded, for example about its longitudinal axis and connected with the outer surface of the tubular bag, for example, by sealing.

### BRIEF DESCRIPTION OF THE DRAWING

The drawing is a section through an inventive tubular bag, as set forth in a composite film with a Finnsel seam.

### DETAILED DESCRIPTION OF THE INVENTION

The drawing is a section through a tubular bag embodying the present invention and formed of a composite film with a Finnsel seam. In the drawing a tubular bag is formed of a composite film 1, composed of several films. For greater clarity, the thicknesses of the individual walls have been enlarged, but not according to scale. The tubular bag serves to accommodate a mortar composition 2, which is enclosed by an inner ply 8 formed of several films. The inner ply 8, in turn, is enclosed by an outer ply 9, which consists of several films.

The inner ply 8 is made up of an inner polyethylene film 3, which is enclosed by a polyamide film 4. The two films are co-extruded and form an independent and completely operative tubular bag, which remains operative even if there has been extensive delamination of the outer ply. Ethyl vinyl alcohol, for example, may be used as bonding agent for carrying out the co-extrusion.

The outer ply 9 includes an inner metal foil 5, such as an aluminum foil, which encloses the inner ply 8. The metal foil 5 is bonded by lamination to the inner ply 8, especially with the polyamide film 4. It forms a so-called total barrier and prevents the diffusion of the chemicals contained in the tubular bag. For the dimensional stability of the tubular bag, a stretched polyamide film 6, for example, is laminated to the metal foil 5. In order to ensure the sealability of the outer ply, a polyethylene film 11 is disposed on the outside of the stretched polyamide film 6.

For forming a bag, the edge regions of the composite film 1 are bonded together at least partially by a seam 7. The latter is arranged in the form of a so-called Finnsel seam by mutually bonded inner plies 8, especially of polyethylene film 3.

1. A tubular bag formed of a composite film (1) for holding a mortar composition (2), containing an epoxide curing agent comprising an inner ply (8) enclosing the mortar composition and an outer ply enclosing the inner ply (8), said inner ply (8) comprises one of a polyethylene film (3) and a polyethylene film along with a polyamide film (4) and said outer ply (9) includes a material impermeable to the epoxide curing agent.

2. A tubular bag, as set forth in claim 1, wherein the one of the polyethylene film (3) and the polypropylene film (3) forms an inner surface of said inner ply (8).

3. A tubular bag as set forth in claim 1, wherein the films (3), (4) of said inner ply (8) are bonded together by a bonding agent.

4. A tubular bag as set forth in claim 1, wherein the films (3), (4) of said inner ply (8) are one of co-extruded and extrusion laminated.

5. A tubular bag, as set forth in claim 1, wherein said outer ply (9) comprises a metal foil (5) forming an inner layer and a stretched plastics material film forming an outer layer.

6. A tubular bag, as set forth in claim 3, wherein said outer ply (9) comprises a metal foil (5) forming an inner layer and a stretched plastics material film forming an outer layer.

7. A tubular bag, as set forth in claim 4, wherein said outer ply (9) comprises a metal foil (5) forming an inner layer and a stretched plastics material film forming an outer layer.

8. A tubular bag, as set forth in claim 5, wherein said stretched plastics material film is one of polypropylene film, polyethylene terephthalate film, polyethylene naphthenate film and polyamide film.

9. A tubular bag, as set forth in claim 6, wherein said stretched plastics material film is one of polypropylene film, polyethylene terephthalate film, polyethylene naphthenate film and polyamide film.

10. A tubular bag, as set forth in claim 7, wherein said stretched plastics material film is one of polypropylene film, polyethylene terephthalate film, polyethylene naphthenate film and polyamide film.

11. A tubular bag, as set forth in claim 1, wherein said inner ply (8) and said outer ply are laminated together.

12. A tubular bag, as set forth in claim 1, wherein the tubular bag is formed with opposite end regions of said inner layer of said inner ply of said composite film (1) are bonded together at least partly to form a seam (7).
